(19) United States
(12) Patent Application Publication
(10) Pub. No.: US 2022/0327958 A1
(43) Pub. Date: Oct. 13, 2022

(54) SURGICAL TRAINING DEVICE

(71) Applicant: Covidien LP, Mansfield, MA (US)

(72) Inventors: Brittney J. Leu, Springfield, NJ (US); Manasvi Varshney, Wallingford, CT (US); Ryan J. Conlan, Stratford, CT (US); Fouzia Raza, Cambridge, MA (US); Stephanie R. DeVita, West Suffield, CT (US); Abigail R. Rockefeller, Columbia, CT (US); Prashant S. Swami, Unionville, CT (US); David M. Pierce, Mansfield Center, CT (US)

(21) Appl. No.: 17/681,869

(22) Filed: Feb. 28, 2022

Related U.S. Application Data
(60) Provisional application No. 63/172,844, filed on Apr. 9, 2021.
(60) Provisional application No. 63/232,287, filed on Aug. 12, 2021.

(51) Int. Cl. G09B 19/24; G09B 23/30; B32B 5/02; B32B 25/10; B32B 25/20; B32B 25/04

(52) U.S. Cl. CPC G09B 19/24; G09B 23/30; B32B 5/024; B32B 25/10; B32B 25/20; B32B 25/042; B32B 2262/148; B32B 2262/0261; B32B 2250/03

(57) ABSTRACT

A surgical training device is provided and includes a first section, a second section, and a third section. The first section includes a first training station and defines a general triangular prism shape. The second section includes a second training station and is configured to engage the first section. The second section defines a general rectangular prism shape. The third section includes a third training station and is configured to engage the second section. The third section defines a general triangular prism shape.

### CROSS-REFERENCE TO RELATED APPLICATION

This application claims the benefit of and priority to U.S. Provisional Patent Application No. 63/172,844, filed on Apr. 9, 2021, and U.S. Provisional Patent Application No. 63/232,287, filed on Aug. 12, 2021, the entire contents of which are incorporated by reference herein.

### BACKGROUND

The disclosure relates to a surgical training system. More specifically, the present disclosure relates to a surgical training system including a surgical training device that can be useful to practice performing various surgical tasks, such as tasks using robotic or remote-controlled instruments.

Robotic assisted surgery (RAS) may be used to perform surgeries with a great degree of control, flexibility and precision. Typically, a robotic surgical system may include an arm supporting a camera, and additional arms that each include a surgical instrument, for instance. The arms of the robotic surgical system may be controlled by a surgeon using a console to perform various surgical tasks, such as minimally invasive surgery.

It may be helpful to provide a surgical training device that facilitates practicing several different types of surgical tasks.

### SUMMARY

The disclosure relates to a surgical training device including a first section, a second section, and a third section. The first section includes a first training station and defines a general triangular prism shape. The second section includes a second training station and is configured to engage the first section. The second section defines a general rectangular prism shape. The third section includes a third training station and is configured to engage the second section. The third section defines a general triangular prism shape.

In aspects, the second section may be configured to selectively engage the first section, and the third section may be configured to selectively engage the second section. In further aspects, the second section may be configured to selectively disengage the first section.

In aspects, the first section may include a curved surface, and the third section may include a curved surface.

In aspects, the first training station may include a synthetic skin. In further aspects, the synthetic skin may be made from a platinum-catalyzed silicone. In further aspects, the second training station may include a plurality of pegs and a plurality of holes. In further aspects, the third training station may include a plurality of undulating tracks.

In further aspects, the surgical training device may include a fourth training station including a plurality of sheets of paper in a stack. At least one sheet of paper of the plurality of sheets of paper may include an image of a shape thereon. The fourth training station may supplement the first training station, the second training station or the third training station; or replace one of the first training station, the second training station or the third training station.

In further aspects, the surgical training device may include a fifth training station having a plurality of eye hooks extending from a curved surface of the third section.

The fifth training station may supplement the first training station, the second training station, the third training station or fourth training station; or replace one of the first training station, the second training station, the third training station or the fourth training station.

The disclosure also relates to a surgical training device including a first station, a second station, and a third station. The first section includes a first training station having a synthetic skin made from a platinum-catalyzed silicone. The second section includes a second training station and is configured to engage the first section. The third section includes a third training station and is configured to engage the second section.

In aspects, the synthetic skin may include a top layer, a middle layer, and a bottom layer. In further aspects, the top layer may be made from platinum-catalyzed silicone and a nylon spandex weave. In further aspects, the middle layer may be made from a platinum silicone rubber gel. In further aspects, the bottom layer may be made from platinum-catalyzed silicone.

The disclosure also relates to a surgical training system including a plurality of robotic surgical instruments, a dome, and a surgical training device. The dome includes a plurality of ports. Each port of the plurality of ports is configured to allow passage of a portion of at least one robotic surgical instrument of the plurality of surgical instruments therethrough. The surgical training device is configured to be positioned within the dome, and includes a first section, a second section, and a third section. The first section has a first training station. The second section has a second training station and is configured to selectively engage the first section. The third section has a third training station and is configured to selectively engage the second section.

In yet another aspect, a surgical training system includes a plurality of robotic surgical instruments; a dome including a plurality of ports, each port of the plurality of ports configured to allow passage of a portion of at least one robotic surgical instrument of the plurality of surgical instruments therethrough; and a surgical training device configured to be positioned within the dome. The surgical training device includes a first section having a first training station; a second section having a second training station, diverse from the first training station; and a third section having a third training station, diverse from the first training station and the second training station.

In aspects, the first section of the surgical training device may define a general triangular prism shape including a curved surface, the second section of the surgical training device may define a general rectangular prism shape, and the third section of the surgical training device may define a general triangular prism shape having a curved surface.

In aspects, the first training station may include a synthetic skin engaged with the curved surface of the first section, and the synthetic skin may be made from a platinum-catalyzed silicone.

### BRIEF DESCRIPTION OF THE DRAWINGS

Embodiments of the present disclosure are described herein with reference to the accompanying drawings, wherein:

FIG. 1 is a perspective view of a surgical training device in accordance with the present disclosure positioned within a training dome and including several robotic surgical devices;

FIG. 2 is a perspective view of the surgical training device of FIG. 1;

FIG. 3 is an assembly view of the surgical training device of FIGS. 1 and 2 with portions removed; and

FIGS. 4-8 are side, elevational views of the surgical training device of FIGS. 1-3 in various orientations within the training dome of FIG. 1.

### DETAILED DESCRIPTION

Aspects of the presently disclosed surgical training device are described in detail with reference to the drawings, in which like reference numerals designate identical or corresponding elements in each of the several views.

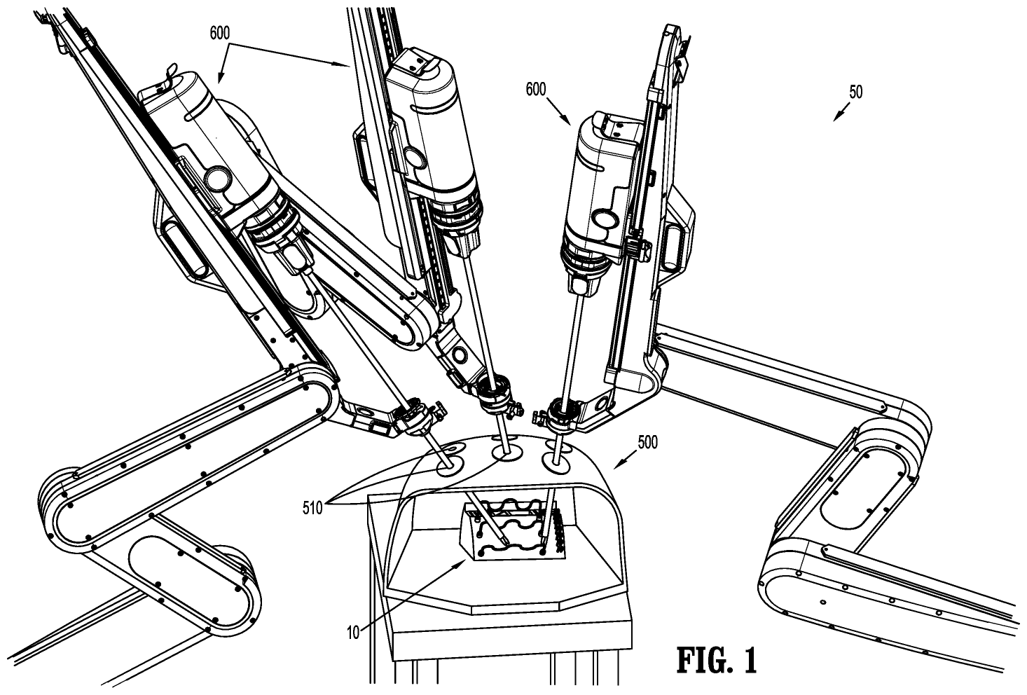

Referring initially to FIG. 1, a surgical training system is shown and generally referred to as reference character 50. The surgical training system 50 includes a surgical training device 10, a training torso or dome 500, and several robotic surgical instruments 600.

The surgical training device 10 is sized and shaped to fit within the training dome 500 and is configured to help simulate various surgical tasks. The training dome 500 includes a plurality of ports or openings 510, which are configured to represent orifices (naturally-occurring or made using an instrument) in a patient. A user may utilize the robotic surgical instruments 600, or other, non-robotic surgical instruments, to practice performing surgical tasks through the openings 510 of the training dome 500, and while using the surgical training device 10. While three robotic surgical instruments 600 are shown in FIG. 1, more or fewer robotic surgical instruments 600 may be used simultaneously in connection with the training dome 500 and the surgical training device 10.

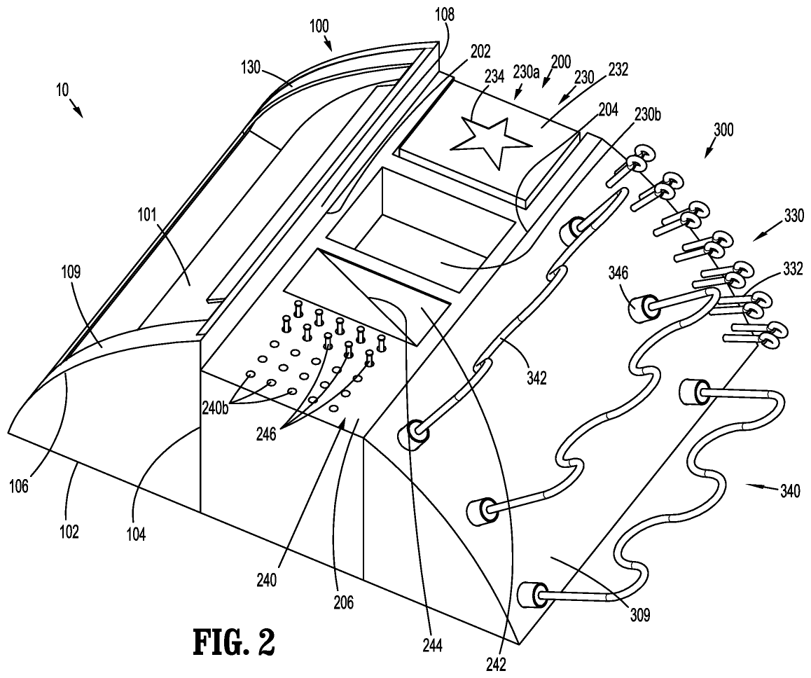

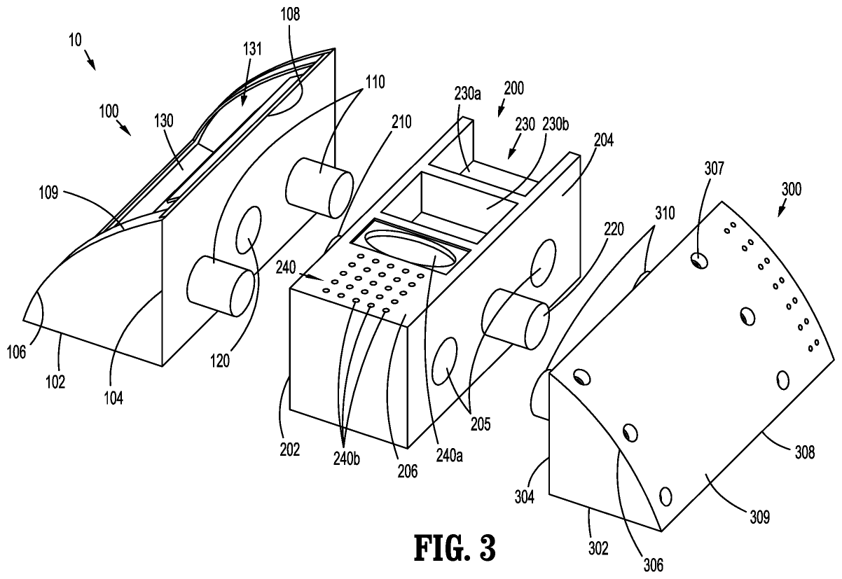

In the aspect illustrated in FIGS. 2 and 3, the surgical training device 10 includes three sections: a first section 100, a second section 200, and a third section 300. Each section 100, 200, 300 includes at least one task or training exercise designed to focus on a particular aspect of training, for example. As shown in FIG. 3, the sections are modular and/or interchangeable. This modularity enables at least one of the sections to be replaced with another section either when one of the sections needs replacement, and/or when a different section including a different training exercise is desired, for instance. Various types of structure may be included to accomplish the modularity. For instance, in the aspect illustrated in FIG. 3, the first section 100 includes a pair of posts 110 that are configured to fit into a pair of openings (not explicitly shown) in the second section 200, and the first section includes an opening 120 that is configured to accept a post 210 of the second section 200; and the third section 300 includes a pair of posts 310 that are configured to fit into a pair of openings 205 in the second section 200, and the third section includes an opening (not explicitly shown) that is configured to accept a post 220 of the second section 200.

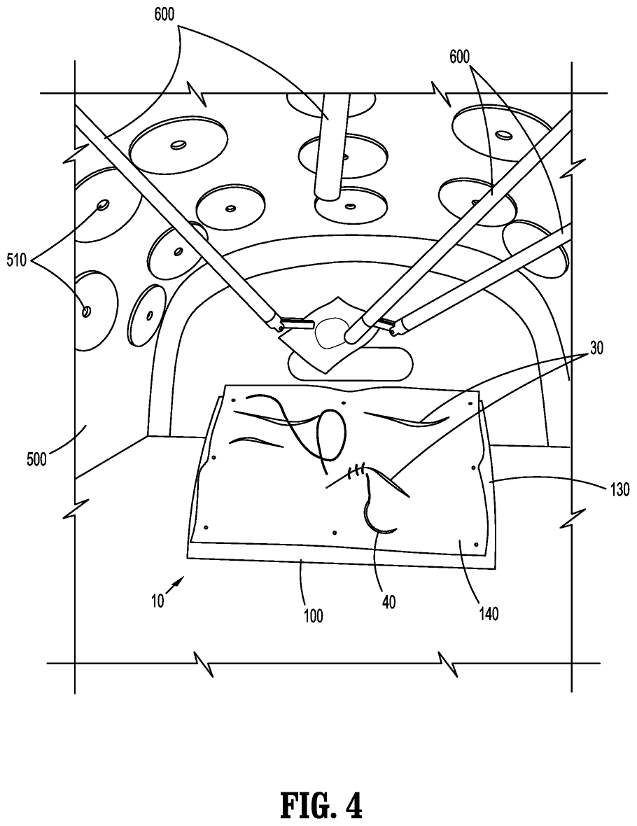

With particular reference to FIGS. 2-4, the first section 100 of the surgical training device 10 is shown. The first section 100 is generally triangular prism-shaped, and includes a first side 102, a second side 104, a third side or hypotenuse 106, and a length 108. As shown, the third side 106 is curved (defining a curved surface 109) to resemble the curvature of an actual surgical site, for instance. In the illustrated aspect, the first section 100 a first training station having a frame 130 that is configured to hold synthetic skin 140 (FIG. 4). The frame 130 is generally trapezoidal and includes angled sides. The wider part of the opening 131 defined by the frame 130 is face down. As shown, the shorter sides of the frame 130 are also curved to match the curvature of the curved surface 109 of the first section 100. The shape of the frame 130 helps ensure the synthetic skin 140 remains in its desired place while being sutured, for instance.

As shown in FIG. 4, the synthetic skin 140 is sized and configured to fit at least partially within the frame 130 of the first section 100. That is, the synthetic skin 140 is generally trapezoidal, includes four angled sides, and two of the sides are also curved. The synthetic skin 140 is configured to allow a user or surgeon to practice suturing and/or cutting (e.g., non-linear suturing and/or cutting) using the robotic surgical instruments 600, suture 30, and a needle 40, for example. The synthetic skin 140 is designed to resemble actual skin, flesh, and/or muscle, such that training using the synthetic skin 140 is as realistic as possible or feasible, and is configured to be removed from the frame 130 and replaced with a new synthetic skin 140, as necessary. In aspects, the frame 130 is at least partially removed from a base 101 (FIG. 2) of the first section 100 to enable removal of the synthetic skin 140 therefrom.

In aspects, the synthetic skin 140 includes a dermis layer, a fat layer, and a muscle layer. In aspects, the dermis layer, or top layer, may be made from rubber or a platinum-catalyzed silicone, such as EcoFlex™ 00-30 (sold by “Smooth-On” of Macungie, Pa.) and a nylon spandex weave. The nylon spandex weave may be helpful to provide a base to facilitate the suturing, and the EcoFlex™ 00-30 may be helpful as its density and thickness emulate properties of human skin. Below the dermis layer is the middle layer, or fat layer, and may be made using a platinum silicone rubber gel, such as EcoFlex™ Gel (sold by “Smooth-On” of Macungie, Pa.), which is a sticky and tacky material that is less dense than the dermis layer, and resembles properties of the layer of fat below the dermis in a human. The bottom layer, or muscle layer, may be made rubber or a platinum-catalyzed silicone, such as EcoFlex™ 00-30, which is sufficiently dense and smooth such that this layer resembles properties of the muscle layer in a human. This bottom layer of synthetic skin 140 is also non-sticky, which facilities using and handling the synthetic skin 140.

In disclosed aspects, the thickness of the dermis layer may be about 0.0625 inches, the thickness of the fat layer may be between about 0.25 inches and about 0.50 inches, and the thickness of the muscle layer may be about 0.125 inches.

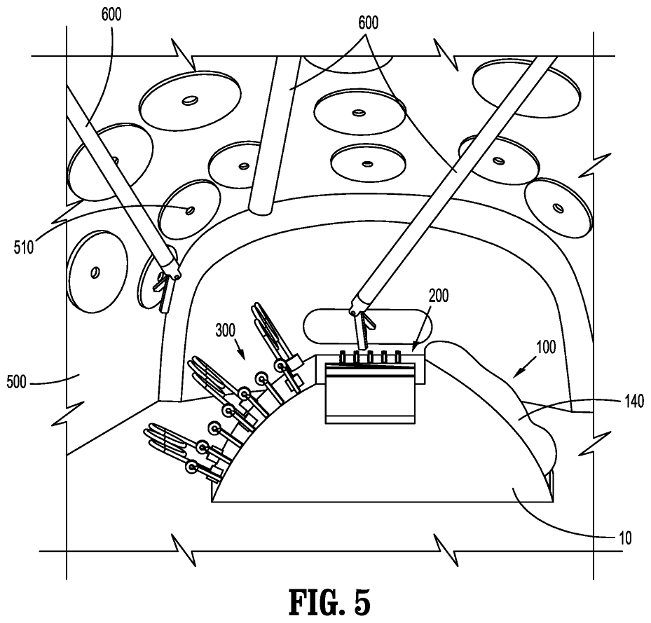

With particular reference to FIGS. 2, 3 and 5, the second section 200 of the surgical training device 10 is shown. The second section 200 is generally rectangular prism-shaped and includes a first side 202 that engages the first section 100, a second side 204 that engages the third section 300, and a top side 206. In the illustrated aspect, the second section 200 includes a first training station 230, and a second training station 240.

The first training station 230 includes a first compartment 230a and a second compartment 230b. A plurality of cards or paper 232 (or another sheet good) is bound together on one end in a stack (to resemble a note pad, for instance), and is positioned in the first compartment 230a. Each sheet of paper 232 has a regular or irregular shape 234 drawn thereon. In aspects, the paper 232 is a dark color (e.g., black), and the shape 234 is drawn using a light/reflective color, such as silver.

The first training station 230 is configured to allow a user or surgeon to practice cutting out the shapes 234 using shears and/or graspers, for instance. In aspects, one or two graspers can be used to remove paper 232 from the stack of papers, and shears can be used to cut the shape 234 out while the paper 232 is being held with the graspers. After the shape 234 is cut out, the shape 234 and/or remaining paper 232 can be placed into the second compartment 230b.

The second training station 240 of the second section 200 includes a first compartment 240a and a plurality of holes 240b. The first compartment 240a is covered with a sheet of material 242 (e.g., spandex) and includes a slit 244 to access the interior of the first compartment 240a. A plurality of pegs 246 is included in the first compartment 240a. Each peg of the plurality of pegs 246 is configured to be removably positioned partially within each hole of the plurality of holes 240b.

The second training station 240 is configured to allow a user or surgeon to practice using multiple pinchers and/or graspers, for instance. In aspects, two graspers can be used to hold open the slit 244 in the sheet of material 242 to allow access to the interior of the first compartment 240a. Then, a third grasper can be used to remove a peg 246 from the first compartment 240a and place the peg 246 into one of the holes of the plurality of holes 240b. After all of the pegs 246 have been positioned within the holes 240b, a user is able to use a grasper to remove the pegs 246 from the holes 240b and place the pegs 246 back into the first compartment 240a.

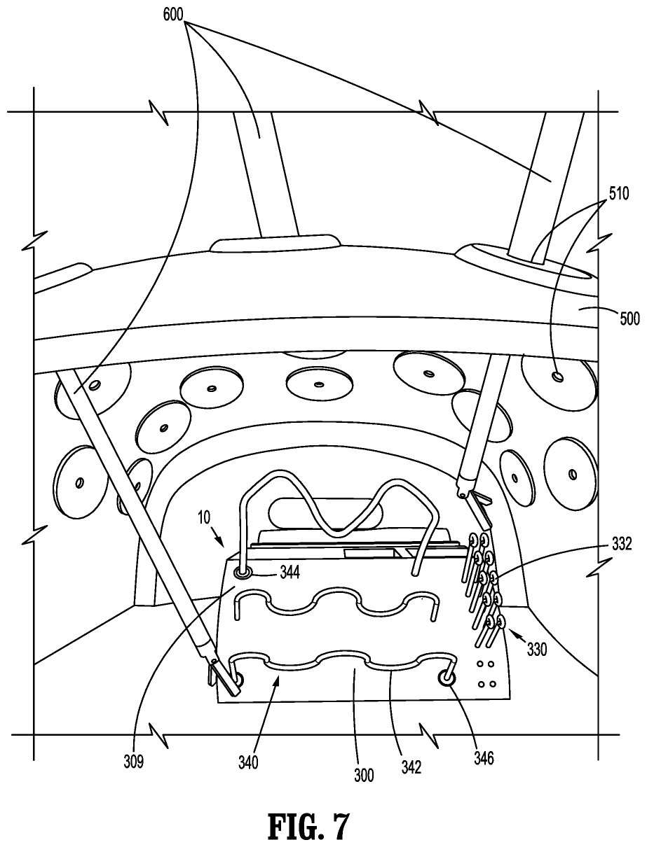

Referring now to FIGS. 2, 3 and 6-8, the third section 300 of the surgical training device 10 is shown. The third section 300 is generally triangular prism-shaped, and includes a first side 302, a second side 304, a third side or hypotenuse 306, and a length 308. As shown, the third side 306 is curved (defining a curved surface 309) to resemble the curvature of the surgical site, for instance. In the illustrated aspect, the third section 300 includes a first training station 330, and a second training station 340.

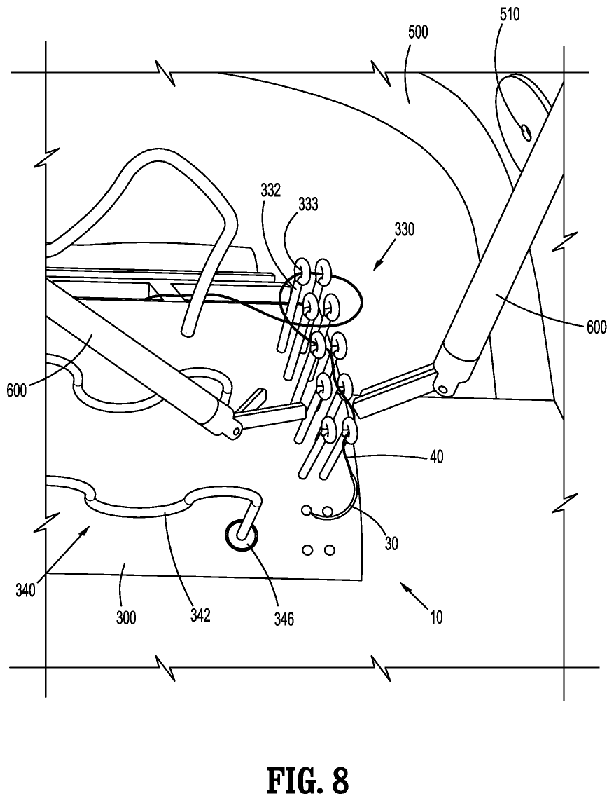

The first training station 330 of the third section 300 includes a plurality of cotter pins or eye hooks 332 protruding from the curved side 309. The first training station 330 is configured to be used as a knot-tying station wherein a user or surgeon can use at least one robotic surgical instrument 600 to thread a needle 30 through an eye 333 of at least one eye hook 332 and create a knot with suture 40 that is tied to the needle 40 (see FIG. 8).

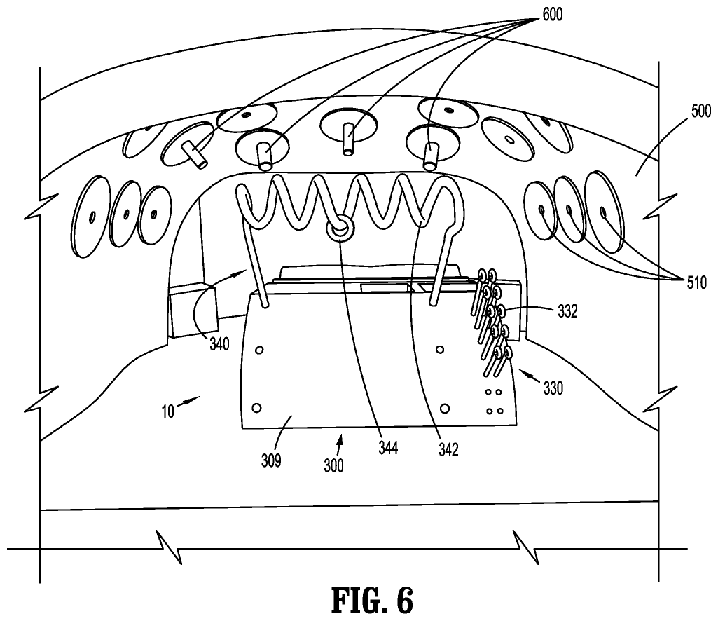

The second training station 340 of the third section 300 includes a plurality of undulating tracks 342, with each track 342 including at least one ring 344 (e.g., FIG. 6) thereon. In use, the surgeon or user may utilize at least one grasper and/or another robotic surgical instrument 600 to grab the ring 344 and move the ring 344 along the corresponding track 342. In aspects, a single track 342 may include a ring 344 and at least one impedance (e.g., an object that obstructs passage of the ring 344), which must be moved (e.g., with an additional robotic surgical instrument 600) and/or avoided, for instance, to properly complete the training exercise.

Additionally, the tracks 342 may include a magnet 346 at the base of each end thereof. Each magnet 346 may be configured for positioning at least partially within or adjacent an opening 307 (FIG. 3) of the third section 300. A corresponding magnet may be positioned within the opening 307, thereby facilitating the removal and replacement of the tracks 342.

In accordance with the disclosure, the training stations may be non-selectively or selectively connected to one another, as necessitated of desired for the particular training program.

It will be understood that various modifications may be made to the embodiments disclosed herein. Therefore, the above description should not be construed as limiting, but merely as exemplifications of various embodiments. Those skilled in the art will envision other modifications within the scope and spirit of the claims appended thereto.

What is claimed:

1. A surgical training device, comprising:
a first section including a first training station, the first section defining a general triangular prism shape;
a second section including a second training station and configured to engage the first section, the second section defining a general rectangular prism shape; and
a third section including a third training station and configured to engage the second section, the third section defining a general triangular prism shape.

2. The surgical training device according to claim 1, wherein the second section is configured to selectively engage the first section.

3. The surgical training device according to claim 2, wherein the third section is configured to selectively engage the second section.

4. The surgical training device according to claim 3, wherein the second section is configured to selectively disengage the first section.

5. The surgical training device according to claim 1, wherein the first section includes a curved surface.

6. The surgical training device according to claim 5, wherein the third section includes a curved surface.

7. The surgical training device according to claim 1, wherein the first training station includes synthetic skin.

8. The surgical training device according to claim 7, wherein the synthetic skin is made from a platinum-catalyzed silicone.

9. The surgical training device according to claim 7, wherein the second training station includes a plurality of pegs and a plurality of holes.

10. The surgical training device according to claim 9, wherein the third training station includes a plurality of undulating tracks.

11. The surgical training device according to claim 10, further comprising a fourth training station including a plurality of sheets of paper in a stack, wherein at least one sheet of paper of the plurality of sheets of paper includes an image of a shape thereon, wherein the fourth training station at least one of:
supplements the first training station, the second training station or the third training station; or
replaces one of the first training station, the second training station or the third training station.

12. The surgical training device according to claim 11, further comprising a fifth training station a plurality of eye hooks extending from a curved surface of the third section, wherein the fifth training station at least one of:
supplements the first training station, the second training station, the third training station or fourth training station; or
replaces one of the first training station, the second training station, the third training station or the fourth training station.

13. A surgical training device, comprising:
a first section including a first training station, the first training station including a synthetic skin made from a platinum-catalyzed silicone;
a second section including a second training station and configured to engage the first section; and
a third section including a third training station and configured to engage the second section.

14. The surgical training device according to claim 13, wherein the synthetic skin includes a top layer, a middle layer, and a bottom layer.

15. The surgical training device according to claim 14, wherein the top layer is made from platinum-catalyzed silicone and a nylon spandex weave.

16. The surgical training device according to claim 15, wherein the middle layer is made from a platinum silicone rubber gel.

17. The surgical training device according to claim 16, wherein the bottom layer is made from platinum-catalyzed silicone.

18. A surgical training system, comprising:
a plurality of robotic surgical instruments;
a dome including a plurality of ports, each port of the plurality of ports configured to allow passage of a portion of at least one robotic surgical instrument of the plurality of surgical instruments therethrough; and
a surgical training device configured to be positioned within the dome, the surgical training device including:
a first section having a first training station;
a second section having a second training station, diverse from the first training station; and
a third section having a third training station, diverse from the first training station and the second training station.

19. The surgical training system according to claim 18, wherein the first section of the surgical training device defines a general triangular prism shape including a curved surface, wherein the second section of the surgical training device defines a general rectangular prism shape, and wherein the third section of the surgical training device defines a general triangular prism shape having a curved surface.

20. The surgical training system according to claim 18, wherein the first training station includes a synthetic skin engaged with the curved surface of the first section, and wherein the synthetic skin is made from a platinum-catalyzed silicone.
